(19) United States
(12) Patent Application Publication
(10) Pub. No.: US 2024/0196297 A1
(43) Pub. Date: Jun. 13, 2024

(54) METHOD, USER EQUIPMENT, NETWORK NODE, AND CORE NETWORK NODE FOR MOBILITY MANAGEMENT

(71) Applicant: NEC Corportion, Minato-ku, Tokyo (JP)

(72) Inventors: Chadi KHIRALLAH, Epsom (GB); Sadafuku HAYASHI, Tokyo (JP); Yuhua CHEN, London (GB)

(73) Assignee: NEC Corportion, Minato-ku, Tokyo (JP)

(21) Appl. No.: 18/285,604

(22) PCT Filed: Apr. 12, 2022
(86) PCT No.: PCT/JP2022/017609

§ 371 Date: Oct. 4, 2023

(30) Foreign Application Priority Data
Apr. 15, 2021 (GB) 2105402.8
May 6, 2021 (GB) 2106477.9

(51) Int. Cl. H04W 36/32; H04W 36/00

(52) U.S. Cl. CPC H04W 36/322; H04W 36/0033

(57) ABSTRACT

A communication system is disclosed that includes a non-terrestrial network portion including a plurality of cells each cell serving at least one coverage area. A first base station stores a UE context associated with a suspended Radio Resource Control (RRC) connection of a user equipment (UE) related to a first coverage area. The UE initiates a procedure for resuming the suspended RRC connection via a second cell serving a different coverage area to the first coverage area, transmits information related to a location of the UE; and receives, from a base station controlling the second cell, a message releasing the RRC connection based on the location of the UE.

### TECHNICAL FIELD

The present disclosure relates to communication system.

### BACKGROUND ART

The present invention relates to a wireless communication system and devices thereof operating according to the 3rd Generation Partnership Project (3GPP) standards or equivalents or derivatives thereof. The disclosure has particular but not exclusive relevance to improvements relating to UE context retrieval/UE redirection in the so-called ‘5G’ (or ‘Next Generation’) systems employing a non-terrestrial portion comprising airborne or spaceborne network nodes.

Under the 3GPP standards, a NodeB (or an ‘eNB’ in LTE, ‘gNB’ in 5G) is a base station via which communication devices (user equipment or ‘UE’) connect to a core network and communicate to other communication devices or remote servers. Communication devices might be, for example, mobile communication devices such as mobile telephones, smartphones, smart watches, personal digital assistants, laptop/tablet computers, web browsers, e-book readers, and/or the like. Such mobile (or even generally stationary) devices are typically operated by a user (and hence they are often collectively referred to as user equipment, ‘UE’) although it is also possible to connect IoT devices and similar MTC devices to the network. For simplicity, the present application will use the term base station to refer to any such base stations and use the term mobile device or UE to refer to any such communication device.

The latest developments of the 3GPP standards are the so-called ‘5G’ or ‘New Radio’ (NR) standards which refer to an evolving communication technology that is expected to support a variety of applications and services such as Machine Type Communications (MTC), Internet of Things (IOT)/Industrial Internet of Things (IIoT) communications, vehicular communications and autonomous cars, high resolution video streaming, smart city services, and/or the like. 3GPP intends to support 5G by way of the so-called 3GPP Next Generation (NextGen) radio access network (RAN) and the 3GPP NextGen core (NGC) network. Various details of 5G networks are described in, for example, the ‘NGMN 5G White Paper’ V1.0 by the Next Generation Mobile Networks (NGMN) Alliance, which document is available from https://www.ngmn.org/5g-white-paper.html.

End-user communication devices are commonly referred to as User Equipment (UE) which may be operated by a human or comprise automated (MTC/IOT) devices. Whilst a base station of a 5G/NR communication system is commonly referred to as a New Radio Base Station (‘NR-BS’) or as a ‘gNB’ it will be appreciated that they may be referred to using the term ‘eNB’ (or 5G/NR eNB) which is more typically associated with Long Term Evolution (LTE) base stations (also commonly referred to as ‘4G’ base stations). 3GPP Technical Specification (TS) 38.300 V16.4.0 and TS 37.340 V16.4.0 define the following nodes, amongst others:

gNB: node providing NR user plane and control plane protocol terminations towards the UE, and connected via the NG interface to the 5G core network (5GC).

ng-eNB: node providing Evolved Universal Terrestrial Radio Access (E-UTRA) user plane and control plane protocol terminations towards the UE, and connected via the NG interface to the 5GC.

En-gNB: node providing NR user plane and control plane protocol terminations towards the UE, and acting as Secondary Node in E-UTRA-NR Dual Connectivity (EN-DC).

NG-RAN node: either a gNB or an ng-eNB.

3GPP is also working on specifying an integrated satellite and terrestrial network infrastructure in the context of 5G. The term Non-Terrestrial Networks (NTN) refers to networks, or segments of networks, that are using an airborne or spaceborne vehicle for transmission. Satellites refer to spaceborne vehicles in Geostationary Earth Orbit (GEO) or in Non-Geostationary Earth Orbit (NGEO) such as Low Earth Orbits (LEO), Medium Earth Orbits (MEO), and Highly Elliptical Orbits (HEO). Airborne vehicles refer to High Altitude Platforms (HAPs) encompassing Unmanned Aircraft Systems (UAS)—including tethered UAS, Lighter than Air UAS and Heavier than Air UAS—all operating quasi-stationary at an altitude typically between 8 and 50 km.

3GPP Technical Report (TR) 38.811 V15.4.0 is a study on New Radio to support such Non-Terrestrial Networks. The study includes, amongst others, NTN deployment scenarios and related system parameters (such as architecture, altitude, orbit etc.) and a description of adaptation of 3GPP channel models for Non-Terrestrial Networks (propagation conditions, mobility, etc.). 3GPP TR 38.821 V16.0.0 provides further details about NTN.

Non-terrestrial networks are expected to:
help foster the 5G service roll out in un-served or underserved areas to upgrade the performance of terrestrial networks;
reinforce service reliability by providing service continuity for user equipment or for moving platforms (e.g. passenger vehicles-aircraft, ships, high speed trains, buses);
increase service availability everywhere: especially for critical communications, future railway/maritime/aeronautical communications; and
enable 5G network scalability through the provision of efficient multicast/broadcast resources for data delivery towards the network edges or even directly to the user equipment.

NTN access typically features the following elements (amongst others):
NTN Terminal: It may refer to a 3GPP UE or a terminal specific to the satellite system in case the satellite doesn't serve directly 3GPP UEs.
A service link which refer to the radio link between the user equipment and the space/airborne platform (which may be in addition to a radio link with a terrestrial based RAN).
A space or an airborne platform.
Gateways (‘NTN Gateways’) that connect the satellite or aerial access network to the core network. It will be appreciated that gateways will mostly likely be co-located with a base station.
Feeder links which refer to the radio links between the gateways and the space/airborne platform.

Satellite or aerial vehicles may generate several beams over a given area to provide respective NTN cells. The beams have a typically elliptic footprint on the surface of the Earth.

3GPP intends to support three types of NTN beams or cells:
Earth-fixed cells characterized by beam(s) covering the same geographical areas all the time (e.g. GEO satellites and HAPS);
quasi-Earth-fixed cells characterized by beam(s) covering one geographic area for a finite period and a different geographic area during another period (e.g. NGEO satellites generating steerable beams); and
Earth-moving cells characterized by beam(s) covering one geographic area at one instant and a different geographic area at another instant (e.g. NGEO satellites generating fixed or non-steerable beams).

With satellite or aerial vehicle keeping position fixed in terms of elevation/azimuth with respect to a given earth point e.g. GEO and UAS, the beam footprint is earth fixed.

With satellite circulating around the earth (e.g. LEO) or on an elliptical orbit around the earth (e.g. HEO) the beam footprint may be moving over the Earth with the satellite or aerial vehicle motion on its orbit. Alternatively, the beam footprint may be Earth-fixed (or quasi-Earth-fixed) temporarily, in which case an appropriate beam pointing mechanism (mechanical or electronic steering) may be used to compensate for the satellite or aerial vehicle motion.

LEO satellites may have steerable beams in which case the beams are temporarily directed to substantially fixed footprints on the Earth. In other words, the beam footprints (which represent NTN cell) are stationary on the ground for a certain amount of time before they change their focus area over to another NTN cell (due to the satellite's movement on its orbit). From cell coverage/UE point of view, this results in cell changes happening regularly at discrete intervals because different Physical Cell Identities (PCIs) and/or Synchronization Signal/Physical Broadcast Channel (PBCH) blocks (SSBs) have to be assigned after each service link change, even when these beams serve the same land area (have the same footprint). LEO satellites without steerable beams cause the beams (cells) moving on the ground constantly in a sweeping motion as the satellite moves along its orbit and as in the case of steerable beams, service link change and consequently cell changes happen regularly at discrete intervals.

Similarly to service link changes, feeder link changes also happen at regular intervals due to the satellite's movement on its orbit. Both service and feeder link changes may be performed between different base stations/gateways (which may be referred to as an ‘inter-gNB radio link switch’) or within the same base station/gateway (‘intra-gNB radio link switch’).

### SUMMARY OF INVENTION

### Technical Problem

3GPP is still working on the detailed specifications, however, it is assumed that Earth fixed tracking areas will be used with Earth fixed and/or moving cells.

Groups of cells are allocated to different coverage areas or service/tracking areas which may correspond to respective geographical areas (such as a country, a city, a region, or any similar geographical unit). Each cell has an associated ‘NR Cell Global Identifier’ (NCGI) which is constructed from the Public Land Mobile Network (PLMN) identity (PLMN ID) the cell belongs to and the NR Cell Identity (NCI) of the cell. The ‘Global gNB ID’ is used to identify a gNB globally and it is constructed from the PLMN identity the gNB belongs to and a gNB ID (which is an identifier for identifying a particular gNB within a PLMN). However, it is not precluded that a cell served by a gNB does not broadcast the associated PLMN ID included in the Global gNB ID. A base station (gNB/NG-RAN node) may control cells in different geographical areas (e.g. different coverage areas, service areas, tracking areas, or countries) or may serve more than one of such geographical areas due to coverage area spill-over across a border between neighbouring areas (when a part of a cell covering a border region in one area extends into a neighbouring area). If the base station serves more than one geographical area, the base station ensures that each UE is using an Access and Mobility Management Function (AMF) that serves the geographical area in which that UE is located (by taking into account UE location information, if available).

A UE may initially establish a Radio Resource Control (RRC) connection via a cell and register with an AMF in one geographical area (e.g. in a first country). Subsequently, after being in RRC Inactive state, the UE may attempt to resume the RRC connection in a cell that belongs to a different base station serving a different geographical area (e.g. in a second country). This may happen for example when the UE moves across the border or when changes in signal conditions cause the UE to select a new cell in another country/area.

The cell where the UE tries to resume the RRC connection (in the new area/country) may not be broadcasting the previous PLMN ID although it may still offer connectivity to an AMF of that PLMN. However, when the UE resumes RRC connectivity in a new area or country the earlier UE context is not suitable for that region and cannot be used in the new cell (even if the new base station is able to recover the UE context from the UE's old base station based on the information from the UE). This will result in a failure of retrieving or using the UE context and hence the RRC connection cannot be resumed at that base station.

Accordingly, the present invention seeks to provide methods and associated apparatus that address or at least alleviate (at least some of) the above described issues.

Although for efficiency of understanding for those of skill in the art, the invention will be described in detail in the context of a 3GPP system (5G networks including NTN), the principles of the invention can be applied to other systems as well.

### Solution to Problem

In one aspect, the invention provides a method performed by a user equipment (UE) configured to communicate via a non-terrestrial network comprising a plurality of cells each cell serving at least one coverage area, wherein a first base station associated with a first coverage area stores a UE context associated with a suspended Radio Resource Control (RRC) connection of the UE, the method comprising: initiating a procedure for resuming the suspended RRC connection via a cell serving a different coverage area to the first coverage area, and transmitting information related to a location of the UE: and receiving, from a base station controlling the cell serving the different coverage area, a message releasing the RRC connection based on the location of the UE.

In one aspect, the invention provides a method performed by a user equipment (UE) configured to communicate via a non-terrestrial network comprising a plurality of cells each cell serving at least one coverage area, wherein the UE has a UE context associated with a suspended Radio Resource Control (RRC) connection related to a first coverage area, the method comprising: determining that a current location of the UE is in a different coverage area to the first coverage area: and releasing the RRC connection based on the current location of the UE.

In one aspect, the invention provides a method performed by a network node configured to communicate with a user equipment (UE) via a non-terrestrial network comprising a plurality of cells each cell serving at least one coverage area, wherein a base station associated with a first coverage area stores a UE context associated with a suspended Radio Resource Control (RRC) connection of the UE, the method comprising: receiving, from the UE, a message initiating a procedure for resuming the suspended RRC connection via a cell serving a different coverage area to the first coverage area, and receiving information related to a location of the UE; and transmitting, to the UE, a message releasing the RRC connection based on the location of the UE.

In one aspect, the invention provides a method performed by a network node configured to communicate with a user equipment (UE) via a non-terrestrial network comprising a plurality of cells each cell serving at least one coverage area, wherein the network node stores a UE context associated with a suspended Radio Resource Control (RRC) connection of the UE related to a first coverage area, the method comprising: receiving, from a base station serving a second coverage area via a cell, information related to a location of the UE: and transmitting, to the base station, when the first and second coverage areas are different, a response for releasing the RRC connection.

In one aspect, the invention provides a method performed by an Access and Mobility Management Function (AMF) configured to communicate with a user equipment (UE) via a non-terrestrial network comprising a plurality of cells each cell serving at least one coverage area, wherein a first base station stores a UE context associated with a suspended Radio Resource Control (RRC) connection of the UE related to a first coverage area, the method comprising: receiving, from a base station serving a second coverage area via a cell, information related to a location of the UE; and transmitting, to the base station serving the second coverage area, when the first and second coverage areas are different, a response for releasing the RRC connection.

In one aspect, the invention provides a user equipment (UE) configured to communicate via a non-terrestrial network comprising a plurality of cells each cell serving at least one coverage area, wherein a first base station associated with a first coverage area stores a UE context associated with a suspended Radio Resource Control (RRC) connection of the UE, the UE comprising: means for initiating a procedure for resuming the suspended RRC connection via a cell serving a different coverage area to the first coverage area, and for transmitting information related to a location of the UE: and means for receiving, from a base station controlling the cell serving the different coverage area, a message releasing the RRC connection based on the location of the UE.

In one aspect, the invention provides a user equipment (UE) configured to communicate via a non-terrestrial network comprising a plurality of cells each cell serving at least one coverage area, wherein the UE has a UE context associated with a suspended Radio Resource Control (RRC) connection related to a first coverage area, the UE comprising: means for determining that a current location of the UE is in a different coverage area to the first coverage area: and means for releasing the RRC connection based on the current location of the UE.

In one aspect, the invention provides a network node configured to communicate with a user equipment (UE) via a non-terrestrial network comprising a plurality of cells each cell serving at least one coverage area, wherein a base station associated with a first coverage area stores a UE context associated with a suspended Radio Resource Control (RRC) connection of the UE, the network node comprising: means for receiving, from the UE, a message initiating a procedure for resuming the suspended RRC connection via a cell serving a different coverage area to the first coverage area, and for receiving information related to a location of the UE: and means for transmitting, to the UE, a message releasing the RRC connection based on the location of the UE.

In one aspect, the invention provides a network node configured to communicate with a user equipment (UE) via a non-terrestrial network comprising a plurality of cells each cell serving at least one coverage area, wherein the network node stores a UE context associated with a suspended Radio Resource Control (RRC) connection of the UE related to a first coverage area, the network node comprising: means for receiving, from a base station serving a second coverage area via a cell, information related to a location of the UE: and means for transmitting, to the base station, when the first and second coverage areas are different, a response for releasing the RRC connection.

In one aspect, the invention provides an Access and Mobility Management Function (AMF) configured to communicate with a user equipment (UE) via a non-terrestrial network comprising a plurality of cells each cell serving at least one coverage area, wherein a first base station stores a UE context associated with a suspended Radio Resource Control (RRC) connection of the UE related to a first coverage area, the AMF comprising: means for receiving, from a base station serving a second coverage area via a cell, information related to a location of the UE: and means for transmitting, to the base station serving the second coverage area, when the first and second coverage areas are different, a response for releasing the RRC connection.

In another aspect, the invention provides a user equipment (UE) configured to communicate via a non-terrestrial network comprising a plurality of cells each cell serving at least one coverage area, wherein a first base station associated with a first coverage area stores a UE context associated with a suspended Radio Resource Control (RRC) connection of the UE, the UE comprising a processor, a transceiver, and a memory storing instructions: wherein the controller is configured to: initiate a procedure for resuming the suspended RRC connection via a cell serving a different coverage area to the first coverage area, and transmit information related to a location of the UE: and control the transceiver to receive, from a base station controlling the cell serving the different coverage area, a message releasing the RRC connection based on the location of the UE.

In another aspect, the invention provides a user equipment (UE) configured to communicate via a non-terrestrial network comprising a plurality of cells each cell serving at least one coverage area, wherein the UE has a UE context associated with a suspended Radio Resource Control (RRC) connection related to a first coverage area, the UE comprising a processor, a transceiver, and a memory storing instructions: wherein the controller is configured to: determine that a current location of the UE is in a different coverage area to the first coverage area: and release the RRC connection based on the current location of the UE.

In another aspect, the invention provides a network node configured to communicate with a user equipment (UE) via a non-terrestrial network comprising a plurality of cells each cell serving at least one coverage area, wherein a base station associated with a first coverage area stores a UE context associated with a suspended Radio Resource Control (RRC) connection of the UE, the network node comprising a processor, a transceiver, and a memory storing instructions: wherein the controller is configured to control the transceiver to: receive, from the UE, a message initiating a procedure for resuming the suspended RRC connection via a cell serving a different coverage area to the first coverage area, and receive information related to a location of the UE; and transmit, to the UE, a message releasing the RRC connection based on the location of the UE.

In another aspect, the invention provides a network node configured to communicate with a user equipment (UE) via a non-terrestrial network comprising a plurality of cells each cell serving at least one coverage area, wherein the network node stores a UE context associated with a suspended Radio Resource Control (RRC) connection of the UE related to a first coverage area, the network node comprising a processor, a transceiver, and a memory storing instructions: wherein the controller is configured to control the transceiver to: receive, from a base station serving a second coverage area via a cell, information related to a location of the UE: and transmit, to the base station, when the first and second coverage areas are different, a response for releasing the RRC connection.

In another aspect, the invention provides an Access and Mobility Management Function (AMF) configured to communicate with a user equipment (UE) via a non-terrestrial network comprising a plurality of cells each cell serving at least one coverage area, wherein a first base station stores a UE context associated with a suspended Radio Resource Control (RRC) connection of the UE related to a first coverage area, the AMF comprising a processor, a transceiver, and a memory storing instructions: wherein the controller is configured to control the transceiver to: receive, from a base station serving a second coverage area via a cell, information related to a location of the UE: and transmit, to the second base station, when the first and second coverage areas are different, a response for releasing the RRC connection.

Aspects of the invention extend to corresponding systems, apparatus, and computer program products such as computer readable storage media having instructions stored thereon which are operable to program a programmable processor to carry out a method as described in the aspects and possibilities set out above or recited in the claims and/or to program a suitably adapted computer to provide the apparatus recited in any of the claims.

Each feature disclosed in this specification (which term includes the claims) and/or shown in the drawings may be incorporated in the invention independently of (or in combination with) any other disclosed and/or illustrated features. In particular but without limitation the features of any of the claims dependent from a particular independent claim may be introduced into that independent claim in any combination or individually.

### BRIEF DESCRIPTION OF DRAWINGS

Embodiments of the invention will now be described, by way of example, with reference to the accompanying drawings in which:

FIG. 1 illustrates schematically a mobile (cellular or wireless) telecommunication system to which embodiments of the invention may be applied:

FIG. 2 is a schematic block diagram of a mobile device forming part of the system shown in FIG. 1;

FIG. 3 is a schematic block diagram of an NTN node (e.g. satellite/UAS platform) forming part of the system shown in FIG. 1;

FIG. 4 is a schematic block diagram of an access network node (e.g. base station) forming part of the system shown in FIG. 1;

FIG. 5 illustrates schematically two exemplary scenarios to which embodiments of the present invention may be applied;

FIG. 6 illustrates schematically two exemplary scenarios to which embodiments of the present invention may be applied;

FIG. 7 is signalling (timing) diagrams illustrating some exemplary ways in which UE context retrieval may be performed in accordance with embodiments of the present invention;

FIG. 8 is signalling (timing) diagrams illustrating some exemplary ways in which UE context retrieval may be performed in accordance with embodiments of the present invention;

FIG. 9 is signalling (timing) diagrams illustrating some exemplary ways in which UE context retrieval may be performed in accordance with embodiments of the present invention;

FIG. 10 is signalling (timing) diagrams illustrating some exemplary ways in which UE context retrieval may be performed in accordance with embodiments of the present invention; and

FIG. 11 illustrates schematically some exemplary architecture options for the provision of NTN features in the system shown in FIG. 1.

### DESCRIPTION OF EMBODIMENTS

### Overview

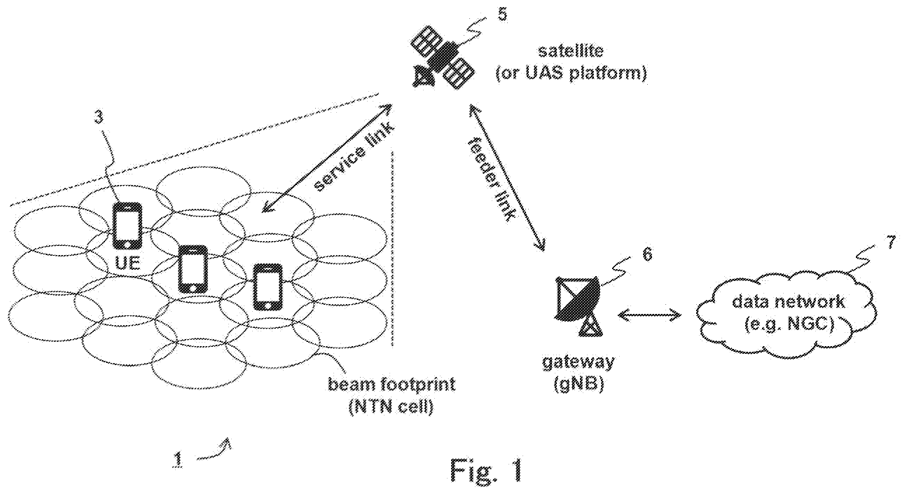

FIG. 1 illustrates schematically a mobile (cellular or wireless) telecommunication system 1 to which embodiments of the invention may be applied.

In this system 1, users of mobile devices 3 (UEs) can communicate with each other and other users via access network nodes respective satellites 5 and/or base stations 6 and a data network 7 using an appropriate 3GPP radio access technology (RAT), for example, an E-UTRA and/or 5G RAT. As those skilled in the art will appreciate, whilst three mobile devices 3, one satellite 5, and one base station 6 are shown in FIG. 1 for illustration purposes, the system, when implemented, will typically include other satellites/UAS platforms, base stations/RAN nodes, and mobile devices (UEs).

It will be appreciated that a number of base stations 6 form a (radio) access network or (R)AN, and a number of NTN nodes 5 (satellites and/or UAS platforms) form a Non-Terrestrial Network (NTN). Each NTN node 5 is connected to an appropriate gateway (in this case co-located with a base station 6) using a so-called feeder link and connected to respective UEs 3 via corresponding service links. Thus, when served by an NTN node 5, a mobile device 3 communicates data to and from a base station 6 via the NTN node 5, using an appropriate service link (between the mobile device 3 and the NTN node 5) and a feeder link (between the NTN node 5 and the gateway/base station 6). In other words, the NTN forms part of the (R)AN, although it may also provide satellite communication services independently of E-UTRA and/or 5G communication services.

Although not shown in FIG. 1, neighbouring base stations 6 are connected to each other via an appropriate base station to base station interface (such as the so-called ‘X2’ interface, ‘Xn’ interface and/or the like). The base station 6 is also connected to the data network nodes via an appropriate interface (such as the so-called ‘S1’, ‘NG-C’, ‘NG-U’ interface, and/or the like).

The data (or core) network 7 (e.g. the EPC in case of LTE or the NGC in case of NR/5G) typically includes logical nodes (or ‘functions’) for supporting communication in the telecommunication system 1, and for subscriber management, mobility management, charging, security, call/session management (amongst others). For example, the data network 7 of a ‘Next Generation’/5G system will include user plane entities and control plane entities, such as one or more control plane functions (CPFs) and one or more user plane functions (UPFs). The so-called Access and Mobility Management Function (AMF) is responsible for handling connection and mobility management tasks for the mobile devices 3. The data network 7 is also coupled to other data networks such as the Internet or similar Internet Protocol (IP) based networks (not shown in FIG. 1).

Each NTN node 5 controls a number of directional beams via which associated NTN cells may be provided. Specifically, each beam has an associated footprint on the surface of the Earth which corresponds to an NTN cell. Each NTN cell (beam) has an associated Physical Cell Identity (PCI) and/or beam identity. The beam footprints may be moving as the NTN node 5 is travelling along its orbit. Alternatively, the beam footprint may be earth fixed, in which case an appropriate beam pointing mechanism (mechanical or electronic steering) may be used to compensate for the movement of the NTN node 5.

Each cell has an associated ‘NR Cell Global Identifier’ (NCGI) to identify the cell globally. The NCGI is constructed from the Public Land Mobile Network (PLMN) identity (PLMN ID) the cell belongs to and the NR Cell Identity (NCI) of the cell. The PLMN ID included in the NCGI is the first PLMN ID within the set of PLMN IDs associated to the NR Cell Identity in System Information Block Type 1 (SIBI). The ‘gNB Identifier’ (gNB ID) is used to identify a particular gNB within a PLMN. The gNB ID is contained within the NCI of its cells. The ‘Global gNB ID’ is used to identify a gNB globally and it is constructed from the PLMN identity the gNB belongs to and the gNB ID. The Mobile Country Code (MCC) and Mobile Network Code (MNC) are the same as included in the NCGI.

Cells serving a particular geographical area are grouped into a coverage area (e.g. a tracking area) that belongs to a PLMN. In this example different groups of cells serve different countries although other types of cell grouping are possible as well.

It will be appreciated that an NTN node 5 may not broadcast the associated PLMN ID for its cell(s). Thus, a mobile device 3 accessing an NTN cell may not be able to determine which PLMN (and which country/area) that cell belongs to. Nevertheless, in this system, the nodes may be configured to ensure that the mobile device 3 is using the correct AMF for the geographical area (in this case country) where the mobile device 3 is located.

In more detail, the mobile device 3 is configured to provide appropriate location assistance information to its new serving base station 6 when the mobile device 3 attempts to resume its RRC connection via a new cell served by that base station 6. This assistance information may be e.g. Global Navigation Satellite System (GNSS) location information, MCC (of the mobile device), and/or any other suitable positioning information. Based on this information, the new serving base station 6 (or the previous serving base station 6) is able to determine whether the UE context and the AMF associated with the mobile device 3 is suitable to use in the area/country/PLMN/cell where the mobile device 3 is currently located, and the base station 6 can manage the RRC connection accordingly.

If the new base station 6 determines, based on the location assistance information and/or the UE context from the old base station 6, that the previously used AMF cannot be used for the new cell, the base station may send the mobile device 3 appropriate redirection information for registering with a new AMF that is suitable for the country/PLMN where the mobile device 3 is currently located.

### User Equipment (UE)

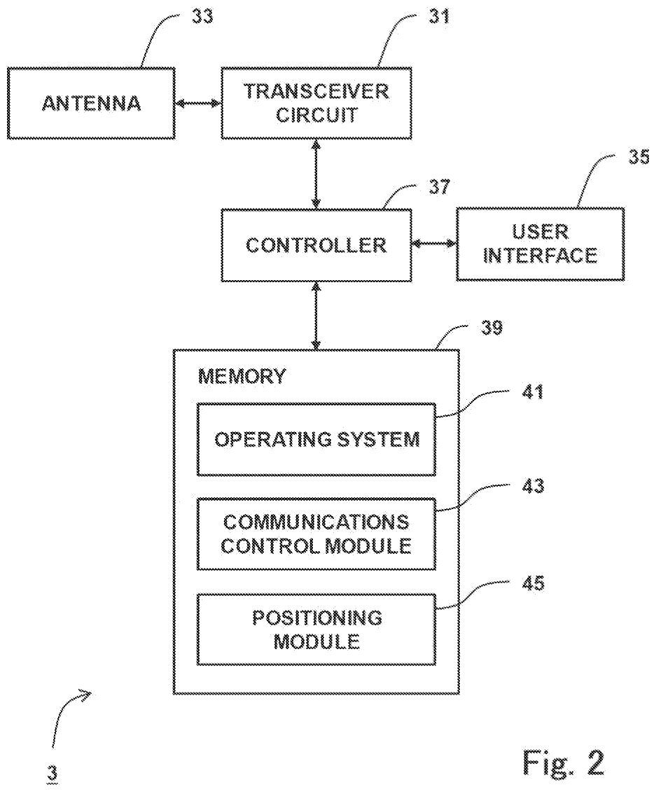

FIG. 2 is a block diagram illustrating the main components of the mobile device (UE) 3 shown in FIG. 1. As shown, the UE 3 includes a transceiver circuit 31 which is operable to transmit signals to and to receive signals from the connected node(s) via one or more antenna 33. Although not necessarily shown in FIG. 2, the UE 3 will of course have all the usual functionality of a conventional mobile device (such as a user interface 35) and this may be provided by any one or any combination of hardware, software and firmware, as appropriate. A controller 37 controls the operation of the UE 3 in accordance with software stored in a memory 39. The software may be pre-installed in the memory 39 and/or may be downloaded via the telecommunication network 1 or from a removable data storage device (RMD), for example. The software includes, among other things, an operating system 41, a communications control module 43, and a positioning module 45.

The communications control module 43 is responsible for handling (generating/sending/receiving) signalling messages and uplink/downlink data packets between the UE 3 and other nodes, including NTN nodes 5, (R)AN nodes 6, and core network nodes. The signalling may comprise control signalling related to UE context retrieval/redirection to a new AMF.

The positioning module 45 (which is optional in some UEs) is responsible for determining the position of the UE 3, for example based on GNSS signals, and for the provision of location assistance information to other nodes when appropriate.

### NTN Node (Satellite/UAS Platform)

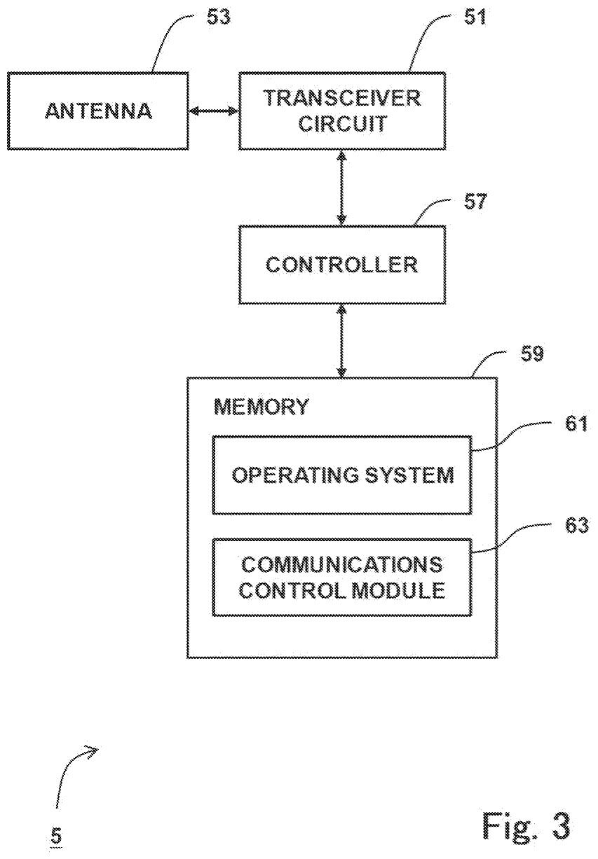

FIG. 3 is a block diagram illustrating the main components of the NTN node 5 (a satellite or a UAS platform) shown in FIG. 1. As shown, the NTN node 5 includes a transceiver circuit 51 which is operable to transmit signals to and to receive signals from connected UE(s) 3 via one or more antenna 53 and to transmit signals to and to receive signals from other network nodes such as gateways and base stations (either directly or indirectly). A controller 57 controls the operation of the NTN node 5 in accordance with software stored in a memory 59. The software may be pre-installed in the memory 59 and/or may be downloaded via the telecommunication network 1 or from a removable data storage device (RMD), for example. The software includes, among other things, an operating system 61, and a communications control module 63.

The communications control module 63 is responsible for handling (generating/sending/receiving) signalling between the NTN node 5 and other nodes, such as the UE 3, base stations 6, gateways, and core network nodes (via the base stations/gateways). The signalling may comprise control signalling related to UE context retrieval/UE redirection to a new AMF.

### Base Station/Gateway (Access Network Node)

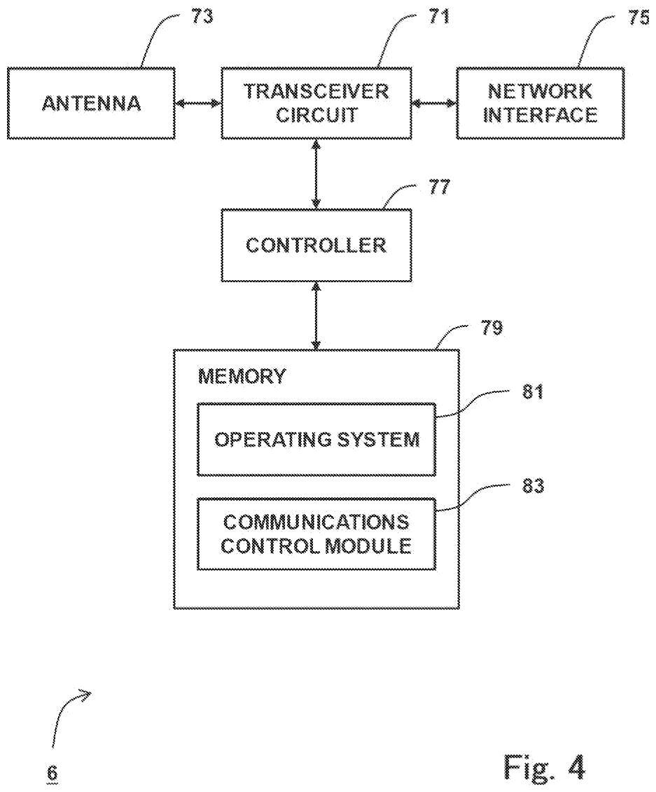

FIG. 4 is a block diagram illustrating the main components of the gateway 6 shown in FIG. 1 (a base station (gNB) or a similar access network node). As shown, the gateway/gNB 6 includes a transceiver circuit 71 which is operable to transmit signals to and to receive signals from connected UE(s) 3 via one or more antenna 73 and to transmit signals to and to receive signals from other network nodes (either directly or indirectly) via a network interface 75. Signals may be transmitted to and received from the UE(s) 3 either directly and/or via the NTN node 5, as appropriate. The network interface 75 typically includes an appropriate base station—base station interface (such as X2/Xn) and an appropriate base station—core network interface (such as S1/NG-C/NG-U). A controller 77 controls the operation of the base station 6 in accordance with software stored in a memory 79. The software may be pre-installed in the memory 79 and/or may be downloaded via the telecommunication network 1 or from a removable data storage device (RMD), for example. The software includes, among other things, an operating system 81, and a communications control module 83.

The communications control module 83 is responsible for handling (generating/sending/receiving) signalling between the base station 6 and other nodes, such as the UE 3, NTN nodes 5, and core network nodes. The signalling may comprise control signalling related to UE context retrieval/UE redirection to a new AMF.

### DETAILED DESCRIPTION

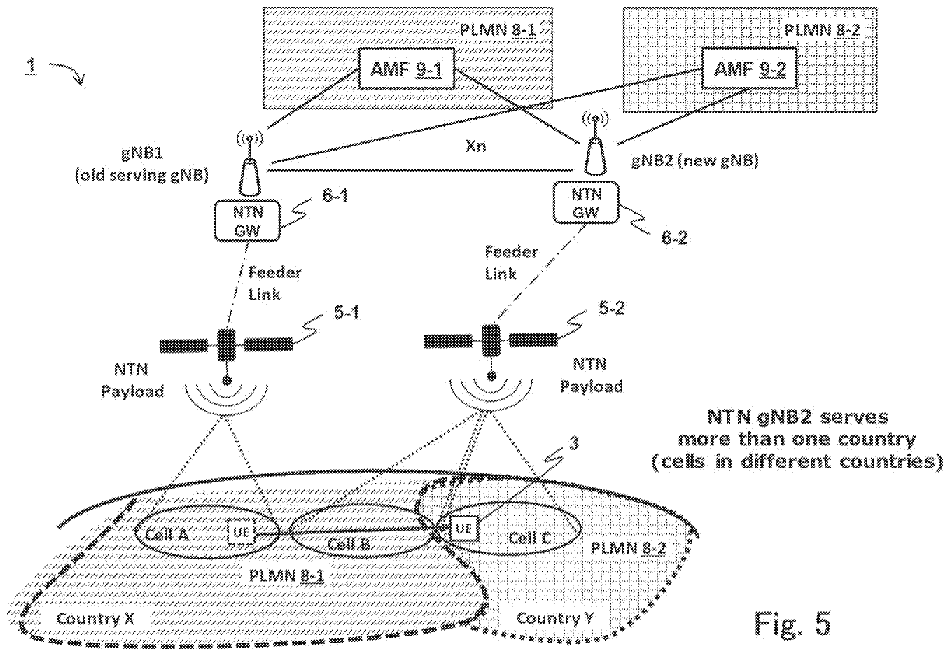

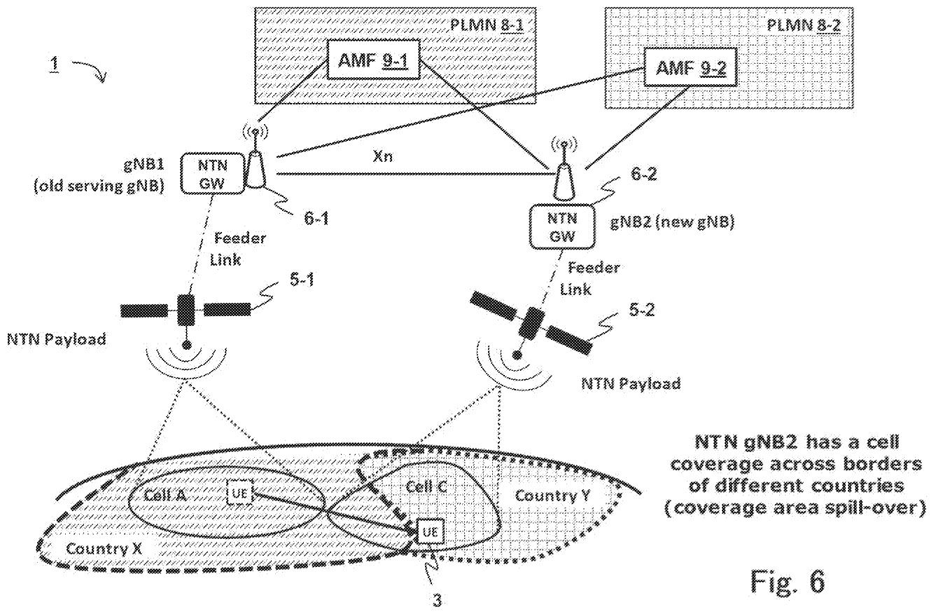

The following is a description of some exemplary procedures (Solutions 1 to 5) for UE redirection in the system shown in FIG. 1, with reference to the scenarios shown in FIGS. 5 and 6.

Specifically, in the scenario shown in FIG. 5 the new base station 6-2 (gNB2) serves more than one country or more than one coverage area (i.e. gNB2 controls cells in different countries, denoted ‘Country X’ and ‘Country Y’ in FIG. 5). In this scenario, the base station 6-2 has connectivity to different AMFs 9-1 and 9-2 serving respective PLMNs 8-1 and 8-2 in different countries/areas. The base station 6-2 has cells that offer coverage to UEs 3 in different countries/areas, i.e. in this example Cells A and B offer coverage in Country X (or coverage area X) and Cell C offers coverage in Country Y (or coverage area Y). One or more cells of the base station 6-2 may not broadcast an PLMN ID included in the Global gNB ID associated with the base station 6-2.

In the scenario shown in FIG. 6 the new base station 6-2 has a cell coverage in different countries/areas due to coverage area spill-over across the border between the countries/areas (which may be caused by the movement of the NTN nodes 5). As in the previous scenario, the base station 6-2 has connectivity to different AMFs 9-1 and 9-2 serving respective PLMNs 8-1 and 8-2 in different countries/areas.

In the above scenarios, the UE 3 establishes an RRC connection with a base station via a cell and registers with an AMF in the country/area/PLMN that the base station serves. In the examples shown in FIGS. 5 and 6, the UE 3 (initially) establishes an RRC connection via ‘Cell A’ of base station 6-1 (‘gNB1’) and registers with AMF 9-1 in ‘Country X’ (PLMN 8-1). When the UE 3 is subsequently released to RRC Inactive state, the RRC connection is suspended and the associated UE context is stored by the base station 6-1 (′gNB1′ which may be referred to as the UE's last/old serving gNB once the UE is in the RRC Inactive state).

Later, when the UE 3 tries to resume the RRC connection, the UE 3 might be located in another cell. In this example, the UE 3 is in Cell C that belongs to a different base station 6-2 (‘gNB2’ or ‘new gNB’), in a different country (Country Y/PLMN 8-2). Thus, the UE 3 tries to resume the RRC connection via Cell C of this base station 6-2 in PLMN 8-2/Country Y. In the present example it is assumed that gNB1 and/or gNB2 have connectivity to both AMF 9-1 serving Country X (of PLMN 8-1) and AMF 9-2 serving Country Y (of PLMN 8-2).

In order to avoid using an unsuitable UE context at the new base station 6-2 (in the new country or new area), the nodes of this system are configured to perform one or more of the following solutions.

### Solution 1

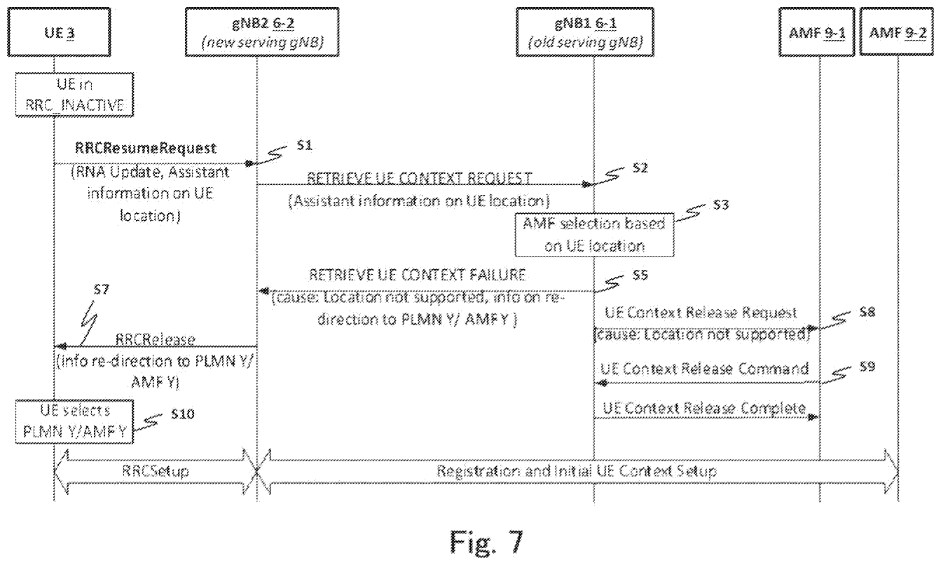

FIG. 7 is signalling (timing) diagram illustrating an exemplary way in which UE context retrieval and subsequent UE redirection may be performed in the above scenarios.

As can be seen, the UE 3 is initially in RRC Inactive state. The associated UE context is stored at the UE's old base station 6-1 (gNB1).

The UE context is related to the coverage area (country) where the base station 6-1 is located (or the country/area that the base station 6-1 serves).

In step S1 the UE 3 sends an appropriately formatted ‘RRCResumeRequest’ message to the new base station 6-2 (gNB2) including assistance information relating to the UE location. This information may be for example Global Navigation Satellite System (GNSS) location information, MCC, and/or any other suitable positioning information. In this and the following examples, the ‘RRCResumeRequest’ message is sent for initiating a RAN Based Notification Area (RNA) update, although the RRC connection may be resumed for other purposes as well, if appropriate.

In step S2 the new base station 6-2 generates and send an appropriately formatted ‘RETRIEVE UE CONTEXT REQUEST’ message to the old serving base station 6-1, and it may include in this message the location assistance information received from the UE. The information elements used in this message and some other details will be summarised in the next section.

In step S3 the old serving base station 6-1 decides, based on the received assistance information and the stored UE context relating to the UE 3, that the UE location in Country Y (where the UE 3 is currently located) does not match the stored UE context from the previous registration on AMF 9-1 serving Country X (corresponding to the UE's earlier location). Thus, the old serving base station 6-1 selects the AMF 9-2 to serve the UE 3 located in Country Y, based on the received assistance information.

The old serving base station 6-1 replies to the new base station 6-2 with a ‘RETREIVE UE CONTEXT FAILURE’ message (step S5), including an RRCRelease message to move the UE 3 to RRC_IDLE (to be forwarded to the UE 3 by the new base station 6-2). Moreover, the ‘RETREIVE UE CONTEXT FAILURE’ message includes an appropriate cause value (e.g. “Location not supported” and/or the like) to indicate the reason the UE context cannot be provided to the new base station 6-2. The old serving base station 6-1 may also include re-direction information for redirecting the UE 3 to PLMN 8-2 (i.e. to perform registration with AMF 9-2 serving Country Y).

In step S7 the new serving base station 6-2 sends an ‘RRCRelease’ message to the UE 3 and may include the re-direction information for AMF 9-2/PLMN 8-2. Effectively, the RRCRelease message instructs the UE 3 to enter the so-called RRC Idle state and delete the context related to the old base station 6-1.

The old serving base station 6-1 also generates and sends, in step S8, an appropriately formatted ‘UE CONTEXT RELEASE REQUEST’ message to the old AMF 9-1, including an appropriate cause value (“Location not supported” and/or the like).

In step S9 the AMF 9-1 releases the UE context in the old serving base station 6-1 (e.g. using the AMF initiated UE Context Release procedure).

As generally shown in step S10, the UE 3 may use the re-direction information (if received) to perform a subsequent registration on AMF 9-2 serving the Country Y, where the UE 3 is located.

The UE 3 may perform a subsequent RRC Setup procedure with the new serving base station 6-2 and perform registration with the appropriate AMF 9-2 serving Country Y (assuming that the UE 3 is located in Country Y).

### Retrieve Ue Context Request

This message is sent by the new NG-RAN node (gNB2) to request the old NG-RAN node (gNB1) to transfer the UE Context to the new NG-RAN.

Direction: new NG-RAN node to old NG-RAN node.

| IE/Group | | | IE type and | | | Assigned |
|---|---|---|---|---|---|---|
| Name | Presence | Range | reference | Semantics description | Criticality | Criticality |
| Message | M | | 9.2.3.1 | | YES | reject |
| Type | | | | | | |
| New NG-RAN | M | | NG-RAN | Allocated at the new NG- | YES | reject |
| node VE | | | node UE | RAN nod | | |
| XnAP ID | | | XnAP ID | | | |
| reference | | | 9.2.3.16 | | | |
| UE Context | M | | 9.2.3.40 | | YES | reject |
| ID | | | | | | |
| RRC Resume | O | | 9.2.3.61 | In case of RNA Update, | YES | ignore |
| Cause | | | | contains the cause value | | |
| | | | | provided by the UE in the | | |
| | | | | RRCResumeRequest or | | |
| | | | | the RRCResumeRequest1 | | |
| | | | | message, as defined in | | |
| | | | | 3GPP TS 38.331, | | |
| | | | | or in the RRCConnection | | |
| | | | | ResumeRequest message, | | |
| | | | | as defined in 3GPP TS | | |
| | | | | 36.331. | | |
| Assistant | O | | | | YES | ignore |
| Information | | | | | | |
| on UE | | | | | | |
| Location or | | | | | | |
| positioning | | | | | | |
| > Location | O | BITSTING | | Each position in the bitmap | YES | ignore |
| Information | | (SIZE(8)) | | represents requested | | |
| Indicator | | | | location information (e.g. | | |
| | | | | as defined in 3GPP TS | | |
| | | | | 37.320). | | |
| | | | | First Bit = GNSS | | |
| | | | | Second Bit = MCC | | |
| | | | | Third Bit = Other | | |
| | | | | Positioning Information | | |
| | | | | Other bits are reserved for | | |
| | | | | future use and are ignored | | |
| | | | | if received. Value “1” | | |
| | | | | indicates “activate” and | | |
| | | | | value “0” indicates “do not | | |
| | | | | activate”. | | |
| >> location | O | OCTET | | For definition of location | YES | ignore |
| information or | | STRING | | information refer to 3GPP | | |
| positioning | | (SIZE(xx)) | | TS 37.355 | | |
| information | | | | | | |
| >> location | O | OCTET | | Mobile Country Code | YES | ignore |
| information or | | STRING | | (MCC) Information. | | |
| positioning | | (SIZE(xx)) | | | | |
| information | | | | | | |
| >> location | O | OCTET | | Other positioning | YES | ignore |
| information or | | STRING | | information. | | |
| positioning | | (SIZE(xx)) | | | | |
| information | | | | | | |
| > Time stamp | O | INTEGER | | This IE indicates the time | YES | ignore |
| | | (0 . . . 172800) | | for logged measurement | | |
| | | | | performed by the UE, or | | |
| | | | | the time the UE reported | | |
| | | | | this information to the NG- | | |
| | | | | RAN node. | | |
| > Measurement | | INTEGER | | This IE indicates the time | YES | ignore |
| validity time | | (0 . . . 172800) | | period that this location | | |
| | | | | information is valid for. | | |

In this example, the Retrieve UE Context Request message includes the location assistance information in a suitable information element (IE) (e.g. Assistant Information on UE Location or positioning IE and/or the like). The message may also include one or more information elements indicating the type of location assistance information (e.g. in a ‘Location Information indicator’ IE or similar) and information relating to the time and validity of the location assistance information (e.g. date stamp IE/validity IE).

### Solution 2

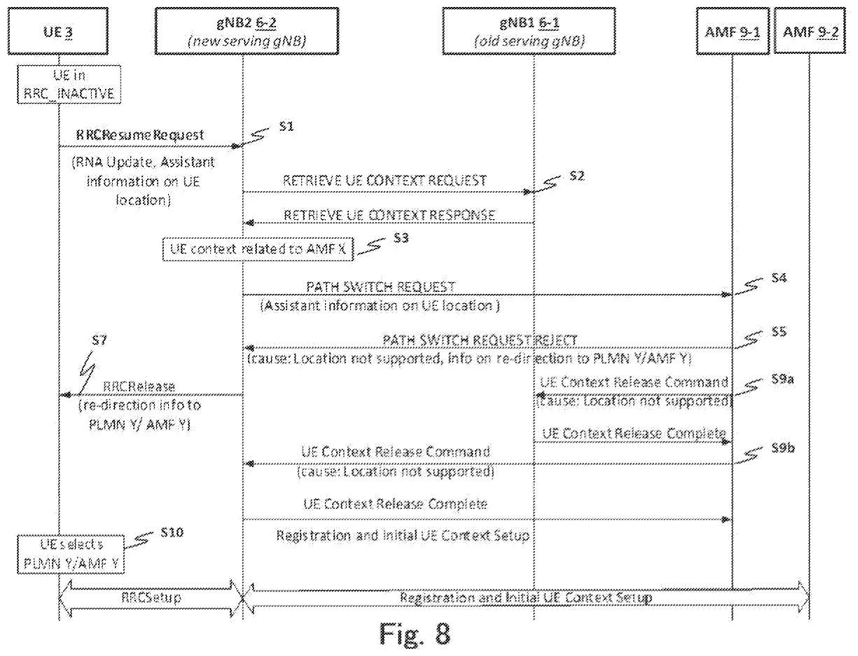

FIG. 8 is signalling (timing) diagram illustrating another exemplary way in which UE context retrieval and subsequent UE redirection may be performed in the above scenarios. In this case the new base station 6-2 determines that the UE context relates to an AMF in another country/another coverage area.

Initially, the UE 3 is in RRC Inactive state and the associated UE context is stored at the UE's old base station 6-1 (gNB1).

In step S1 the UE 3 generates and sends an appropriately formatted ‘RRCResumeRequest’ message to the new base station 6-2 (gNB2) including assistance information relating to the UE location. This information may be for example GNSS location information, MCC, and/or any other suitable positioning information.

In step S2 the new base station 6-2 and the old base station 6-1 perform a UE context retrieval procedure (which comprises the new base station 6-2 sending a ‘RETRIEVE UE CONTEXT REQUEST’ and receiving an appropriate ‘RETRIEVE UE CONTEXT RESPONSE’ from the old base station 6-1). During this UE context retrieval procedure the new base station 6-2 receives the UE context related to UE's previous registration. Thus, as shown in step S3, the new serving base station 6-2 determines, based on the received assistance information and the UE context relating to the UE 3, that the UE location in Country Y (where the UE 3 is currently located) does not match the UE context from the previous registration on AMF 9-1 serving Country X (corresponding to the UE's earlier location).

Thus, the new serving base station 6-2 generates and sends, in step S4, an appropriately formatted ‘Path Switch Request’ to the AMF 9-1, including the assistance information received from the UE 3.

The old AMF 9-1 determines that it does not support the current UE location (Country Y) and rejects the path switch request by generating and sending (step S5) an appropriately formatted ‘Path Switch Request Reject’ message to the base station 6-2 with an appropriate cause value (“location not supported”). Additionally, the AMF 9-1 may also send information on re-direction of the UE 3 to a suitable AMF 9-2 serving Country Y.

In step S7 the new serving base station 6-2 sends an ‘RRCRelease’ message to the UE 3 and may include the re-direction information for AMF 9-2/PLMN 8-2. Based on the RRCRelease message the UE 3 enters the RRC Idle state and deletes the context related to the old base station 6-1.

In steps S9a and 9b the AMF 9-1 initiates release of the UE context in the old serving base station 6-1 and the new serving base station 6-2 (e.g. using the AMF initiated UE Context Release procedure).

The UE 3 may perform a subsequent RRC Setup procedure with the new serving base station 6-2 and register with the appropriate AMF 9-2 serving Country Y.

### Solution 3

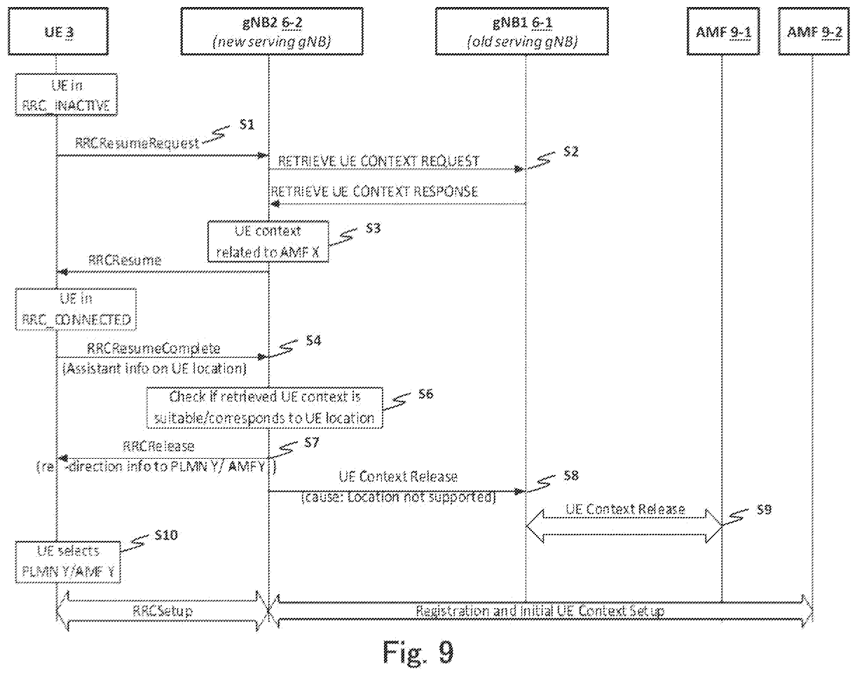

FIG. 9 is signalling (timing) diagram illustrating another exemplary way in which UE context retrieval may be performed in the above scenarios.

Initially, the UE 3 is in RRC Inactive state and the associated UE context is stored at the UE's old base station 6-1 (gNB1). In this case the UE 3 provides location assistance information when it enters the RRC connected state.

In more detail, the UE 3 sends an appropriately formatted ‘RRCResumeRequest’ message to the new base station 6-2 (gNB2). However, this message does not include information relating to the UE location or the information (if included) may not be processed by the new base station 6-2 at this stage.

In step S2 the new base station 6-2 and the old base station 6-1 perform a UE context retrieval procedure as described above, and the new base station 6-2 receives the UE context related to UE's previous registration.

In this case the new base station 6-2 instructs the UE 3 to resume the RRC connection (by sending an RRCResume message) and the UE 3 enters the RRC Connected state. In step S4 the 3 UE generates and sends, to the new base station 6-2, an appropriately formatted ‘RRCResumeComplete’ message including assistance information relating to the UE location (e.g. GNSS location information, MCC, and/or any other suitable positioning information).

As shown in step S6, the new serving base station 6-2 checks, based on the location assistance information (reported in step S4 or alternatively in step S1) whether the UE's current location (in Country Y) matches the UE context from the previous registration on AMF 9-1 serving Country X (corresponding to the UE's earlier location). If the UE 3 is located in Country Y (served by AMF 9-2), the new serving base station 6-2 determines that the retrieved UE context (related to AMF 9-1) is not suitable for the UE location in Country Y.

Thus, the new serving base station 6-2 generates and sends, in step S7, an appropriately formatted RRCRelease message to the UE 3 which may also include information on re-direction to the PLMN 8-2 of Country Y (served by AMF 9-2). This causes the UE 3 to enter the RRC Idle state and delete the context related to the old base station 6-1.

The new serving base station 6-2 also sends, in step S8, an appropriately formatted UE Context Release message to the old serving base station 6-1, and then the old base station 6-1 and the old AMF 9-1 perform an appropriate UE Context Release procedure (step S9).

The UE 3 may perform a subsequent RRC Setup procedure with the new serving base station 6-2 and register with the appropriate AMF 9-2 serving Country Y.

### Solution 4

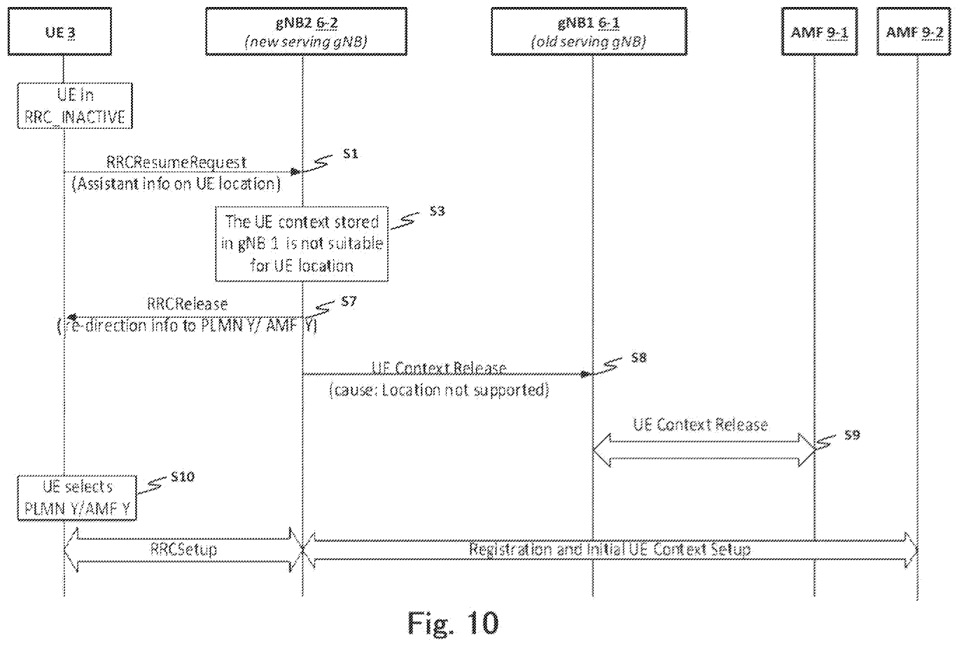

FIG. 10 is signalling (timing) diagram illustrating yet another exemplary way in which UE context retrieval may be performed. In this case the new base station 6-2 determines that the UE context stored in the old base station 6-1 is not suitable for the UE's current location.

In more detail, the UE 3 is initially in the RRC Inactive state and the associated UE context is stored at the UE's old base station 6-1 (gNB1).

In step S1 the UE 3 generates and sends an appropriately formatted ‘RRCResumeRequest’ message to the new base station 6-2 (gNB2) including assistance information relating to the UE location (e.g. GNSS location information, MCC, and/or any other suitable positioning information).

As shown in step S3, the new base station 6-2 checks, based on the location assistance information whether the UE's current (in Country Y) matches the country or area where the UE's old base station 6-1 is located (in this case Country X corresponding to the UE's earlier location). The new base station 6-2 decides not to retrieve the UE context from the old base station 6-1 (even though these base stations may be connected via an appropriate Xn interface), since a UE context from the old base station 6-1 and/or any associated AMF would not be suitable for the reported UE location (in Country Y in this example). For example, the new base station 6-2 may know that the old base station 6-1 is located in Country X, which is served by AMF 9-1/PLMN 8-1. Such information may be available from information exchanged between the base stations 6-1 and 6-2 relating to their supported PLMNs (e.g. a PLMN list) and/or their supported coverage areas during Xn setup (between gNB2 and gNB1).

Thus, the new serving base station 6-2 generates and sends, in step S7, an appropriately formatted RRCRelease message to the UE 3 which may also include information on re-direction to the PLMN 8-2 of Country Y (served by AMF 9-2). This causes the UE 3 to enter the RRC Idle state and delete the context related to the old base station 6-1.

The new serving base station 6-2 also sends, in step S8, an appropriately formatted UE Context Release message to the old serving base station 6-1, and then the old base station 6-1 and the old AMF 9-1 perform an appropriate UE Context Release procedure (step S9).

If appropriate, the UE 3 may perform an RRC Setup procedure with the new serving base station 6-2 and register with the appropriate AMF 9-2 serving Country Y.

### RRCRelease Message (Solutions 1 to 4)

The following is an overview of the RRCRelease message and associated information elements that may be sent by a base station 6 (e.g. gNB2) to request the UE 3 to select and register with a suitable AMF for the UE's location. In this example, the RRCRelease message includes a suitable IE (e.g. a ‘RedirectedPLMNAMFInfo’ IE and/or the like) that identifies a PLMN (e.g. based on its associated PLMN Identity) and an AMF (using a ‘ReselectedAMF’ IE and/or the like) to be used in the cell of the new base station 6-2 (‘Cell C’ in FIGS. 5 and 6). The RRC Release (‘RRCRelease’) message is used here as an exemplary message for instructing the UE 3 to register with an AMF serving the UE's location (current country/area). It will be appreciated that other suitable messages may be used, such as an RRC Reject message or an RRC redirection message, and/or the like. The names of the information elements are also used here as examples. Other suitable information elements (or information) may be used if appropriate, e.g. ‘PLMN name’, ‘PLMN index’, ‘AMF name’, ‘AMF address’, ‘AMF group’, ‘Core Network identifier’ and/or the like.

| RRCRelease-vxyz-IEs ::= | SEQUENCE { | |
|---|---|---|
| redirectedPLMNAMFInfo | RedirectedPLMNAMFInfo | OPTIONAL, -- Need N |
| nonCriticalExtension | SEQUENCE { } | OPTIONAL |

}

| | |
|---|---|
| RedirectedPLMNAMFInfo ::= | CHOICE { |
| plmn-Identity | PLMN-Identity, |
| reselectedAMF | ReselectedAMF, |

...
}

| PLMN-Identity ::= | SEQUENCE { | |
|---|---|---|
| mcc | MCC | OPTIONAL, -- Cond MCC |

| | |
|---|---|
| mnc | MNC |

}

| MCC ::= | SEQUENCE (SIZE (3)) OF MCC-MNC-Digit | |
|---|---|---|
| MNC ::= | SEQUENCE (SIZE (2..3)) OF MCC-MNC-Digit | |
| MCC-MNC-Digit ::= | INTEGER (0..9) | |
| ReselectedAMF ::= | SEQUENCE { | |
| plmn-Identity | PLMN-Identity | OPTIONAL, |

| | |
|---|---|
| amf-Identifier | AMF-Identifier |

}

| | |
|---|---|
| AMF-Identifier ::= | BIT STRING (SIZE (24)) |

### Modifications and Alternatives

Detailed embodiments have been described above. As those skilled in the art will appreciate, a number of modifications and alternatives can be made to the above embodiments whilst still benefiting from the inventions embodied therein. By way of illustration only a number of these alternatives and modifications will now be described.

It will be appreciated that the above embodiments may be applied to both 5G New Radio and LTE systems (E-UTRAN). A base station (gateway) that supports E-UTRA/4G protocols may be referred to as an ‘eNB’ and a base station that supports NextGeneration/5G protocols may be referred to as a ‘gNBs’. It will be appreciated that some base stations may be configured to support both 4G and 5G protocols, and/or any other 3GPP or non-3GPP communication protocols.

It will be appreciated that in an NTN deployment scenario, the base station (NG-RAN node) may serve multiple countries/areas using multiple cells (scenario 1) or using a single cell (scenario 2). In this case, the base station may broadcast, via a suitable system information block (SIB), an appropriate indication that it serves multiple countries/areas (using different cells, or a single cell). This indication may be in the form of 1 bit and may have the following values and interpretation:
“1” the UE needs to provide its location when accessing cell(s) of the NG-RAN node
“0” the UE does not need to provide its location to the NG-RAN node.

A UE that has location measurement/reporting capability may be configured to provide its location as part of RRC messaging with the NG-RAN (e.g. in the RRC Resume Request or the RRC Resume Complete message). Alternatively, a UE with location measurement/reporting capability (e.g. GNSS, etc.) may be configured to release itself and move into the RRC_IDLE state when crossing into a different country or a different coverage area. A UE with no location measurement/reporting capability (e.g. no GNSS, MCC, etc.) may be prevented from accessing a new NG-RAN node in another country/coverage area.

Section 10.1 of 3GPP TR 38.857 V18.0.0 provides further information on positioning for UEs in RRC_INACTIVE state. In summary, the following positioning techniques have been considered:
Downlink (DL), Uplink (UL), and DL+UL positioning methods;
UE-based and UE-assisted positioning solutions;
Support of UE positioning measurements for UEs in RRC_inactive state;
Options that can be considered include Downlink Positioning Reference Signal (DL-PRS) or DL-PRS and Synchronization Signal Block (SSB);
Support of gNB positioning measurements for UEs in RRC_inactive state.

In order to enable UE positioning in RRC_INACTIVE state the following techniques may be used:
UL reference signals (e.g. Sounding Reference Signal (SRS) for positioning, Physical Random Access Channel (PRACH) preambles) for UL measurements;
Signalling and procedures to support the assistance data delivery, DL-PRS configuration, UL reference signals for positioning resource configuration, measurement reporting, which may be developed based on the enhancements of existing signalling and procedures (e.g., existing 2-step and/or 4-step PRACH procedures, paging procedure, small data transmission).

The following procedures may be used for DL positioning in RRC_INACTIVE:
Reporting of DL-PRS measurement and/or location estimate performed in RRC INACTIVE when the UE is in RRC INACTIVE;
The reporting of DL-PRS measurement and/or location estimate performed in RRC_INACTIVE when the UE is in RRC INACTIVE is enabled by enhancing small data transmission in RRC_INACTIVE;
On-demand system information request in RRC_INACTIVE for assistance data delivery by broadcast in RRC_INACTIVE;
ProvideAssistanceData in RRC_CONNECTED for DL-PRS configuration used in RRC_INACTIVE downlink positioning;
RequestLocationInformation can be sent in RRC_CONNECTED for DL-PRS measurement or location estimate performed in RRC_INACTIVE.

It will be appreciated that the UE may be configured to derive its location using any of the above techniques, and the UE may provide location assistance information accordingly.

TABLE 1
types of satellites and UAS platforms

| | | | | Typical beam | |
|---|---|---|---|---|---|
| Platforms | Altitude range | | Orbit | footprint size | |
| Low-Earth Orbit | 300-1500 | km | Circular around the earth | 100-1000 | km |
| (LEO) satellite | | | | | |
| Medium-Earth Orbit | 7000-25000 | km | | 100-1000 | km |
| (MEO) satellite | | | | | |
| Geostationary Earth | 35 786 | km | Notional station keeping | 200-3500 | km |
| Orbit (GEO) satellite | | | position fixed in terms of | | |
| UAS platform | 8-50 km | | elevation/azimuth with | 5-200 | km |
| (including HAPS) | (20 km for HAPS) | | respect to a given earth point | | |
| High Elliptical Orbit | 400-50000 | km | Elliptical around the earth | 200-3500 | km |

(HEO) satellite

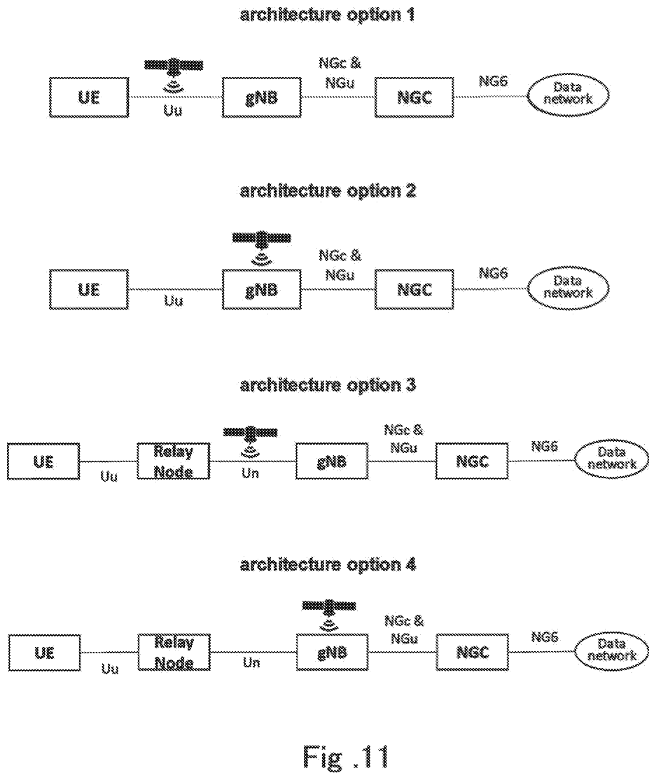

It will be appreciated that there are various architecture options to implement NTN in a 5G system, some of which are illustrated schematically in FIG. 11. The first option shown is an NTN featuring an access network serving UEs and based on a satellite/aerial with bent pipe payload and gNB on the ground (satellite hub or gateway level). The second option is an NTN featuring an access network serving UEs and based on a satellite/aerial with gNB on board. The third option is an NTN featuring an access network serving Relay Nodes and based on a satellite/aerial with bent pipe payload. The fourth option is an NTN featuring an access network serving Relay Nodes and based on a satellite/aerial with gNB. It will be appreciated that other architecture options may also be used, for example, a combination of two or more of the above described options. Alternatively, the relay node may comprise a satellite/UAS.

In the above description, the UE, the NTN node (satellite/UAS platform), and the access network node (base station) are described for ease of understanding as having a number of discrete modules (such as the communication control modules). Whilst these modules may be provided in this way for certain applications, for example where an existing system has been modified to implement the invention, in other applications, for example in systems designed with the inventive features in mind from the outset, these modules may be built into the overall operating system or code and so these modules may not be discernible as discrete entities. These modules may also be implemented in software, hardware, firmware or a mix of these.

Each controller may comprise any suitable form of processing circuitry including (but not limited to), for example: one or more hardware implemented computer processors: microprocessors: central processing units (CPUs): arithmetic logic units (ALUs): input/output (IO) circuits; internal memories/caches (program and/or data): processing registers; communication buses (e.g. control, data and/or address buses); direct memory access (DMA) functions: hardware or software implemented counters, pointers and/or timers: and/or the like.

In the above embodiments, a number of software modules were described. As those skilled in the art will appreciate, the software modules may be provided in compiled or un-compiled form and may be supplied to the UE, the NTN node, and the access network node (base station) as a signal over a computer network, or on a recording medium. Further, the functionality performed by part or all of this software may be performed using one or more dedicated hardware circuits. However, the use of software modules is preferred as it facilitates the updating of the UE, the NTN node, and the access network node (base station) in order to update their functionalities.

The above embodiments are also applicable to ‘non-mobile’ or generally stationary user equipment. The above described mobile device may comprise an MTC/IoT device and/or the like.

The information related to the location of the UE may comprise at least one of a Global Navigation Satellite System (GNSS) based location and a Mobile Country Code (MCC) associated with the UE.

The method performed by the UE may comprise transmitting said information related to the location of the UE in at least one of an ‘RRCResumeRequest’ message and an ‘RRCResumeComplete’ message.

The method performed by the UE may further comprise receiving information for redirecting the UE to an AMF associated with the location of the UE. For example, the method may comprise receiving an RRCRelease message or an RRCReject message comprising said information for redirecting the UE to an AMF associated with the location of the UE. The method performed by the UE may further comprise setting up an RRC connection via the second cell and selecting an AMF based on the received information.

The method performed by the UE may further comprise receiving, in the second cell (e.g. via system information), an indication whether to transmit information related to a location of the UE and transmitting said information based on the received indication.

The method performed by the network node may further comprise transmitting said information related to a location of the UE to said base station and determining whether to release the RRC connection based on a response from the base station. For example, the method may comprise transmitting said information to said base station in a Retrieve UE Context Request message.

The method performed by the network node may further comprise transmitting said information related to a location of the UE to an Access and Mobility Management Function (AMF) associated with the first coverage area and determining whether to release the RRC connection based on a response from the AMF. For example, the method may comprise transmitting said information to the AMF in a Path Switch Request message.

The network node may comprise a gateway or a base station apparatus.

The response from the AMF to the network node (second base station) may comprise at least one of: a cause value identifying that said location is not supported for the UE; and information for redirecting the UE to another AMF associated with the location of the UE.

Various other modifications will be apparent to those skilled in the art and will not be described in further detail here.

For example, the whole or part of the exemplary embodiments disclosed above can be described as, but not limited to, the following supplementary notes.

### Supplementary Note 1

A method performed by a user equipment (UE) configured to communicate via a non-terrestrial network including a plurality of cells, each cell serving at least one coverage area, wherein a first base station associated with a first coverage area stores a UE context associated with a suspended Radio Resource Control (RRC) connection of the UE, the method comprising:
initiating a procedure for resuming the suspended RRC connection via a cell serving a different coverage area to the first coverage area; transmitting information related to a location of the UE: and receiving, from a base station controlling the cell serving the different coverage area, a message for releasing the suspended RRC connection based on the location of the UE.

### Supplementary Note 2

The method according to note 1, wherein the information includes at least one of:
a Global Navigation Satellite System (GNSS) based location; and
a Mobile Country Code (MCC) associated with the UE.

### Supplementary Note 3

The method according to note 1 or 2, wherein the information is included in at least one of an RRCResumeRequest message and an RRCResumeComplete message.

### Supplementary Note 4

The method according to any one of notes 1 to 3, further comprising receiving information for redirecting the UE to a core network node for mobility management associated with the location of the UE.

### Supplementary Note 5

The method according to note 4, wherein the information for redirecting the UE is included in an RRCRelease message or an RRCReject message.

### Supplementary Note 6

The method according to note 4 or 5, further comprising:
setting up an RRC connection via the cell serving the different coverage area: and
selecting the core network node based on the information for redirecting the UE.

### Supplementary Note 7

The method according to any one of notes 1 to 6, further comprising: receiving, in the cell serving the different coverage area, an indication whether to transmit information related to the location of the UE, wherein
the transmitting the information is performed based on the indication.

### Supplementary Note 8

A method performed by a user equipment (UE) configured to communicate via a non-terrestrial network including a plurality of cells, each cell serving at least one coverage area, wherein the UE has a suspended Radio Resource Control (RRC) connection related to a first coverage area, the method comprising:
determining that a current location of the UE is in a different coverage area to the first coverage area: and releasing the suspended RRC connection based on the current location of the UE.

### Supplementary Note 9

A method performed by a network node configured to communicate with a user equipment (UE) via a non-terrestrial network including a plurality of cells, each cell serving at least one coverage area, wherein a base station associated with a first coverage area stores a UE context associated with a suspended Radio Resource Control (RRC) connection of the UE, the method comprising:
receiving, from the UE, a message for initiating a procedure for resuming the suspended RRC connection via a cell serving a different coverage area to the first coverage area;
receiving information related to a location of the UE; and
transmitting, to the UE, a message for releasing the suspended RRC connection based on the location of the UE.

### Supplementary Note 10

The method according to note 9, further comprising:
transmitting the information to the base station;
receiving, from the base station, a response to the information; and determining whether to release the suspended RRC connection based on the response.

### Supplementary Note 11

The method according to note 10, wherein the transmitting the information to the base station includes transmitting in a Retrieve UE Context Request message.

### Supplementary Note 12

The method according to note 9, further comprising:
transmitting the information to a core network node for mobility management associated with the first coverage area;
receiving, from the core network node, a response to the information; and
determining whether to release the suspended RRC connection based on the response.

### Supplementary Note 13

The method according to note 12, wherein the transmitting the information to the core network node includes transmitting in a Path Switch Request message.

### Supplementary Note 14

The method according to any one of notes 10 to 13, wherein the response includes at least one of:
a cause value identifying that the location is not supported for the UE; and
information for redirecting the UE to a core network node for mobility management associated with the location of the UE.

### Supplementary Note 15

A method performed by a network node configured to communicate with a user equipment (UE) via a non-terrestrial network including a plurality of cells, each cell serving at least one coverage area, wherein the network node stores a UE context associated with a suspended Radio Resource Control (RRC) connection of the UE related to a first coverage area, the method comprising:
receiving, from a base station serving a second coverage area via a cell, information related to a location of the UE: and
transmitting, to the base station, in a case where the first and second coverage areas are different, a response for releasing the suspended RRC connection.

### Supplementary Note 16

The method according to note 15, wherein the information is included in a Retrieve UE Context Request message.

### Supplementary Note 17

The method according to any one of notes 9 to 16, wherein the network node includes a gateway or a base station.

### Supplementary Note 18

A method performed by a core network node for mobility management configured to communicate with a user equipment (UE) via a non-terrestrial network including a plurality of cells, each cell serving at least one coverage area, wherein a first base station stores a UE context associated with a suspended Radio Resource Control (RRC) connection of the UE related to a first coverage area, the method comprising: receiving, from a base station serving a second coverage area via a cell, information related to a location of the UE; and transmitting, to the base station serving the second coverage area, in a case where the first and second coverage areas are different, a response for releasing the suspended RRC connection.

### Supplementary Note 19

The method according to note 18, wherein the response includes at least one of:
a cause value identifying that the location is not supported for the UE; and
information for redirecting the UE to another core network node for mobility management associated with the location of the UE.

### Supplementary Note 20

A user equipment (UE) configured to communicate via a non-terrestrial network including a plurality of cells, each cell serving at least one coverage area, wherein a first base station associated with a first coverage area stores a UE context associated with a suspended Radio Resource Control (RRC) connection of the UE, the UE comprising: means for initiating a procedure for resuming the suspended RRC connection via a cell serving a different coverage area to the first coverage area:
means for transmitting information related to a location of the UE; and
means for receiving, from a base station controlling the cell serving the different coverage area, a message for releasing the suspended RRC connection based on the location of the UE.

### Supplementary Note 21

A user equipment (UE) configured to communicate via a non-terrestrial network including a plurality of cells, each cell serving at least one coverage area, wherein the UE has a UE context associated with a suspended Radio Resource Control (RRC) connection related to a first coverage area, the UE comprising:
means for determining that a current location of the UE is in a different coverage area to the first coverage area: and means for releasing the suspended RRC connection based on the current location of the UE.

### Supplementary Note 22

A network node configured to communicate with a user equipment (UE) via a non-terrestrial network including a plurality of cells, each cell serving at least one coverage area, wherein a base station associated with a first coverage area stores a UE context associated with a suspended Radio Resource Control (RRC) connection of the UE, the network node comprising:
means for receiving, from the UE, a message for initiating a procedure for resuming the suspended RRC connection via a cell serving a different coverage area to the first coverage area;
means for receiving information related to a location of the UE: and means for transmitting, to the UE, a message for releasing the suspended RRC connection based on the location of the UE.

### Supplementary Note 23

A network node configured to communicate with a user equipment (UE) via a non-terrestrial network including a plurality of cells, each cell serving at least one coverage area, wherein the network node stores a UE context associated with a suspended Radio Resource Control (RRC) connection of the UE related to a first coverage area, the network node comprising:
means for receiving, from a base station serving a second coverage area via a cell, information related to a location of the UE; and means for transmitting, to the base station, in a case where the first and second coverage areas are different, a response for releasing the suspended RRC connection.

### Supplementary Note 24

A core network node for mobility management configured to communicate with a user equipment (UE) via a non-terrestrial network including a plurality of cells, each cell serving at least one coverage area, wherein a first base station stores a UE context associated with a suspended Radio Resource Control (RRC) connection of the UE related to a first coverage area, the core network node comprising:
means for receiving, from a base station serving a second coverage area via a cell, information related to a location of the UE; and
means for transmitting, to the base station serving the second coverage area, in a case where the first and second coverage areas are different, a response for releasing the suspended RRC connection.

This application is based upon and claims the benefit of priority from Great Britain Patent Application No. 2105402.8, filed on Apr. 15, 2021, and Great Britain Patent Application No. 2106477.9, filed on May 6, 2021, the disclosures of which are incorporated herein in its entirety by reference.

### REFERENCE SIGNS LIST

1 Mobile telecommunication system
3 Users of mobile devices
5 Satellite
6 Base station
7 Data network
31 Transceiver circuit
33 Antenna
35 User interface
37 Controller
39 Memory
41 Operating system
43 Communications control module
45 Positioning module
51 Transceiver circuit
53 Antenna
57 Controller
59 Memory
61 Operating system
63 Communications control module
71 Transceiver circuit
73 Antenna
75 Network interface
77 Controller
79 Memory
81 Operating system
83 Communications control module

What is claimed is:

1-24. (canceled)

25. A method performed by a user equipment (UE) configured to communicate via a non-terrestrial network, wherein a first base station operating a cell serving a first coverage area stores a UE context associated with a suspended Radio Resource Control (RRC) connection of the UE, the method comprising:
transmitting a first message for initiating a procedure for resuming the suspended RRC connection via a cell serving a different coverage area from the first coverage area, the cell being operated by a second base station;
transmitting information related to a location of the UE; and
receiving, from the second base station, a second message for releasing the suspended RRC connection based on whether the UE context is available in the location of the UE.

26. The method according to claim 25, wherein
the receiving is performed based on whether a core network node for mobility management associated with the UE is available in the location of the UE.

27. The method according to claim 25, wherein
the information is included in the first message.

28. The method according to claim 25, further comprising:
receiving information for redirecting the UE to a core network node for mobility management associated with the location of the UE.

29. The method according to claim 28, wherein
the information for redirecting the UE is included in the second message.

30. The method according to claim 28, further comprising:
setting up another RRC connection via the cell serving the different coverage area; and
selecting the core network node based on the information for redirecting the UE.

31. The method according to claim 25, further comprising:
receiving, in the cell serving the different coverage area, an indication indicating whether to transmit the information related to the location of the UE, wherein
the transmitting the information is performed based on the indication.

32. The method according to claim 25, wherein
the information includes at least one of:
a Global Navigation Satellite System (GNSS) based location; and
a Mobile Country Code (MCC) associated with the UE.

33. The method according to claim 25, wherein
the first message includes at least one of:
an RRCResumeRequest message; and
an RRCResumeComplete message.

34. The method according to claim 25, wherein
the second message includes at least one of:
an RRCRelease message; and
an RRCReject message.

35. A method performed by a network node configured to communicate with a user equipment (UE) via a non-terrestrial network, wherein a base station operating a cell serving a first coverage area stores a UE context associated with a suspended Radio Resource Control (RRC) connection of the UE, the method comprising:
receiving, from the UE, a first message for initiating a procedure for resuming the suspended RRC connection via a cell serving a different coverage area from the first coverage area, the cell being operated by the network node;
receiving information related to a location of the UE; and
transmitting, to the UE, a second message for releasing the suspended RRC connection based on whether the UE context is available in the location of the UE.

36. The method according to claim 35, further comprising:
transmitting the information related to the location of the UE to another network node;
receiving, from the another network node, information indicating whether the UE context is available in the location of the UE; and
determining whether to release the suspended RRC connection based on the information indicating whether the UE context is available in the location of the UE.

37. The method according to claim 36, wherein
the information indicating whether the UE context is available in the location of the UE includes at least one of:
a cause value identifying that the location is not supported for the UE; and
information for redirecting the UE to a core network node for mobility management associated with the location of the UE.

38. The method according to claim 36, wherein
the another network node includes:
the base station; or
a core network node for mobility management.

39. The method according to claim 35, further comprising:
receiving, from the base station, the UE context; and
determining whether to release the suspended RRC connection based on whether the UE context is available in the location of the UE.

40. The method according to claim 35, wherein
the information related to the location of the UE is included in the first message.

41. A method performed by a network node configured to communicate with a user equipment (UE) via a non-terrestrial network, the method comprising:
storing a UE context associated with a suspended Radio Resource Control (RRC) connection of the UE related to a first coverage area;
receiving, from a base station serving a different coverage area from the first coverage area via a cell, information related to a location of the UE; and
transmitting, to the base station, information indicating whether the UE context is available in the location of the UE for determining whether to release the suspended RRC connection.

42. A user equipment (UE) configured to communicate via a non-terrestrial network, wherein a first base station operating a cell serving a first coverage area stores a UE context associated with a suspended Radio Resource Control (RRC) connection of the UE, the UE comprising:
a memory storing instructions; and
at least one processor configured to process the instructions to:
transmit a first message for initiating a procedure for resuming the suspended RRC connection via a cell serving a different coverage area from the first coverage area, the cell being operated by a second base station;
transmit information related to a location of the UE; and
receive, from the second base station, a message for releasing the suspended RRC connection based on whether the UE context is available in the location of the UE.

43. A network node configured to communicate with a user equipment (UE) via a non-terrestrial network, wherein a base station operating a cell serving a first coverage area stores a UE context associated with a suspended Radio Resource Control (RRC) connection of the UE, the network node comprising:
a memory storing instructions; and
at least one processor configured to process the instructions to:
receive, from the UE, a first message for initiating a procedure for resuming the suspended RRC connection via a cell serving a different coverage area from the first coverage area, the cell being operated by the network node;
receive information related to a location of the UE; and
transmit, to the UE, a second message for releasing the suspended RRC connection based on whether the UE context is available in the location of the UE.

44. A network node configured to communicate with a user equipment (UE) via a non-terrestrial network, the network node comprising:
a memory storing instructions; and
at least one processor configured to process the instructions to:
store a UE context associated with a suspended Radio Resource Control (RRC) connection of the UE related to a first coverage area;
receive, from a base station serving a different coverage area from the first coverage area via a cell, information related to a location of the UE; and
transmit, to the base station, information indicating whether the UE context is available in the location of the UE for determining whether to release the suspended RRC connection.
